(19) United States
(12) Patent Application Publication
(10) Pub. No.: US 2011/0317153 A1
(43) Pub. Date: Dec. 29, 2011

(54) LASER PEAK ENERGY POINT CALIBRATION METHOD AND APPARATUS

(75) Inventor: Michael Bruce Holmberg, San Francisco, CA (US)

(73) Assignee: APPLE INC., Cupertino, CA (US)

(21) Appl. No.: 12/822,557

(22) Filed: Jun. 24, 2010

(51) Int. Cl. G01J 1/20

(52) U.S. Cl. 356/122

(57) ABSTRACT

A method and apparatus for determining a focus point of a laser system is described. A reference datum surface is aligned with a laser emitter arranged to emit a laser beam. A portion of the laser beam reflects from the reference datum surface and is captured by a photon detector. Based upon the captured photons, intensity level data is generated each time the laser emitter is moved relative to the reference datum surface. A maximum intensity level is then determined in accordance with the distance moved by the laser emitter associated with the focus point of the laser system. In some cases, an interpolation is performed to provide a more accurate determination of the location of the focus point, the interpolation being in one case a second order polynomial.

### BACKGROUND

1. Field of the Invention

The invention relates to a manufacturing process. More particularly techniques and apparatus for calibrating an optical system are described.

2. Description of the Related Art

Lasers in manufacturing have become ubiquitous. Lasers can produce a prodigious amount of heat in a small volume providing an excellent tool for heat treating materials. For example, lasers can be used for spot welding as well as selective ablation. However, in order to assure that the laser energy is applied to only the material to be ablated, the energy distribution of the laser beam must be well characterized. One of the most important characteristics of the laser beam is referred to as the focus point. The focus point corresponds to a region of the laser beam having a maximal laser energy density. In order to avoid damaging a workpiece undergoing laser ablation, the focus point of the laser must be known to a relatively high degree of accuracy especially in those situations where resolution of the features on the workpiece is on the order of the alignment tolerance of the laser.

In order to overcome the problem of accurately characterizing a laser beam focus point, some manufacturers of laser based manufacturing equipment have installed at great cost, automatic laser focusing systems into their machines. Although generally accurate, the laser focusing systems are quite expensive and in reality are seldom used thereby making them even more costly in relative terms.

Therefore, what is desired is a cost effective, highly accurate technique and system for calibrating laser manufacturing equipment in a production environment.

### SUMMARY

This paper describes various embodiments that relate to methods and apparatus for automatically determining a focus point of a laser system in real time.

A method of automatically determining a focus point of a laser system is carried out by at least placing a reference datum surface a first distance from a laser emitter structure of the laser system, the laser emitter structure arranged to emit a plurality of photons as a laser beam, directing the laser beam from the laser emitter structure to the reference datum surface, determining a light intensity level based upon a number of photons reflected from the reference datum structure captured at a photon detector, the photon detector being a fixed distance from the reference datum surface, moving the laser emitter structure a pre-determined distance, repeating the directing, the determining, and the moving until the light intensity is determined to be a maximum light intensity, and identifying the focus point of the laser system based upon a location of the laser emitter structure in relation to the reference datum surface corresponding to the maximum light intensity.

An apparatus for determining a focus point of a laser beam formed of a plurality of photons emitted by a laser emitter of a laser system includes a support structure having at least one surface as the reference datum surface, a photon detector, a fixed length arm used to attach the photon detector and the support structure in such a way that a distance between the reference datum surface and the photon detector is fixed. The apparatus automatically determines the focus point of the laser beam by directing the laser beam at the reference datum surface by the laser emitter such that at least some of the plurality of photons comprising the laser beam are reflected off of the reference datum surface, capturing at least some of the reflected photons by the photon detector, determining and storing for subsequent processing intensity level data in accordance with the reflected photons captured by the photon detector, and moving the laser emitter in relation to the reference datum surface a predetermined distance, wherein the directing, capturing, and determining and storing are repeated until the intensity level is determined to be at least a relative maximum intensity level.

A non-transitory computer readable medium for storing a computer program executable by a processor for determining a focus point of a laser system is described that includes computer code for placing a reference datum surface a first distance from a laser emitter structure of the laser system, the laser emitter structure arranged to emit a plurality of photons as a laser beam, computer code for directing the laser beam from the laser emitter structure to the reference datum surface, computer code for determining a light intensity level based upon a number of photons reflected from the reference datum structure captured at a photon detector, the photon detector being a fixed distance from the reference datum surface, computer code for moving the laser emitter structure a pre-determined distance, computer code for repeating the directing, the determining, and the moving until the light intensity is determined to be a maximum light intensity, and computer code for identifying the focus point of the laser system based upon a location of the laser emitter structure in relation to the reference datum surface corresponding to the maximum light intensity.

In one embodiment, a least differences second order approximation interpolation technique is used to determine the focus point (peak energy point) of the laser system. This approximation improves accuracy of peak energy point determination by averaging the measurement system error over many data points.

A method for calibrating a plurality of laser machines can be performed using the laser focus apparatus by calibrating a first one of the plurality of laser machines using the automatic laser focus apparatus, moving the automatic laser focus apparatus to another one of the plurality of laser machines, calibrating the another one of the plurality of laser machines using the automatic laser focus apparatus, and repeating the moving and calibrating until substantially all of the plurality of laser machines are calibrated. In the described embodiment, the calibration data for each of the calibrated laser machines are stored in an external computing system.

Other aspects and advantages will become apparent from the following detailed description taken in conjunction with the accompanying drawings which illustrate, by way of example, the principles of the invention.

### BRIEF DESCRIPTION OF THE DRAWINGS

The described embodiments will be readily understood by the following detailed description in conjunction with the accompanying drawings, wherein like reference numerals designate like structural elements, and in which:

FIG. 1 shows a representative cross section of a laser beam illustrating beam divergence.

FIG. 2 shows representative laser focus unit in accordance with the described embodiments.

FIG. 3 shows an arrangement whereby the laser focus unit of FIG. 2 can be used to determine a focus point of a laser system.

FIG. 4 shows a representative convergence curve used to determine a focus point of a system using a set of discrete measured values.

FIG. 5 shows a flowchart detailing a process for determining a focus point of a laser system in accordance with the embodiments.

### DETAILED DESCRIPTION OF THE DESCRIBED EMBODIMENTS

In the following detailed description, numerous specific details are set forth to provide a thorough understanding of the concepts underlying the described embodiments. It will be apparent, however, to one skilled in the art that the described embodiments can be practiced without some or all of these specific details. In other instances, well known process steps have not been described in detail in order to avoid unnecessarily obscuring the underlying concepts.

A UV laser can be used to cleanly and with great precision remove many substances from practically any surface. For example, ink can be removed from a glass surface in a process known as laser ablation using energy from the UV laser to vaporize the ink which can then be removed as would any gas. However, in order for the ablation process to remove the ink efficiently and without damaging the underlying glass substrate, most of the energy from the laser that is not reflected off of the surface must be absorbed by the ink alone. Since the glass substrate is essentially transparent to the light in the UV part of the electromagnetic spectrum (10 nm-400 nm), the UV laser can efficiently remove the ink and leave the glass substrate essentially untouched. However, in order to maximize the likelihood of an acceptable result, the laser must be tuned to the material characteristics of the ink, the glass substrate, as well as the laser machine itself.

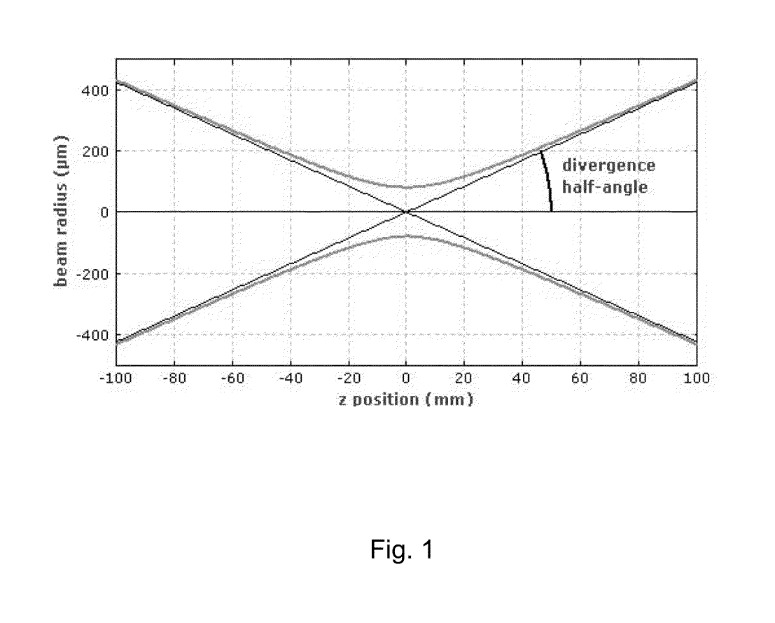

Accordingly, laser parameters such as current, q·stop frequency, marking speed (speed at which laser can move) and focus point (relative to a laser emitter structure or a workpiece) can all have significant impact on the quality of the result of the ablation process. As with all electromagnetic beams, lasers are subject to divergence as shown in FIG. 1. The divergence of a laser beam is proportional to its wavelength and inversely proportional to the diameter of the beam at its narrowest point (referred to as the beam focus point, or more simply focus point). For example, for laser beams having the same minimum beam diameter, an ultraviolet laser that emits at a wavelength of 308 nm will have a lower divergence than an infrared laser at 808 nm. Beams with very small divergence, i.e., with approximately constant beam radius over significant propagation distances, are called collimated beams and can be modeled using the mathematics of a Gaussian curve.

The position of the focus point can be a very important parameter since it indicates a region of maximum energy density of the laser beam. The position of focus point, however, can depend upon specific machine characteristics that can vary from laser machine to laser machine. One approach used to determine the position of a laser focus point is to equip production laser machines with auto focus mechanisms that although accurate are expensive and since they are rarely needed are seldom used. Accordingly, many manufacturers have opted to use a manual approach to determine the position of the focus point of a laser machine that relies upon an operator directly observing laser light reflected off of a surface of the workpiece while adjusting the Z position of the laser head (laser emitter structure). When the reflected light appears to the operator to be at a maximum brightness level, the inference is that the laser focus point is now positioned directly at the surface of the workpiece. At this point, the operator notes the current Z position as that corresponding to the focus point of the laser machine.

Clearly the manual approach has many drawbacks not the least of which is that the overall accuracy is dependent upon an operator's subjective opinion of the maximum brightness that can change from one operator to another as well as from time to time for the same operator. Moreover, the laser machines themselves have limited Z position accuracy on the order of about +/±0.2 mm that when compared to the Z stack of a typical glass substrate and ink (1 mm and 0.045 mm, respectively) call into question the accuracy of the estimated position of the laser focus point. Clearly then the manual approach is not very accurate or repeatable and subjects the operators to unknown health risks.

Therefore in order to overcome these and other drawbacks, a method and apparatus for determining (either manually or automatically) a laser focus point as well as calibrating a laser machine used in a manufacturing process is described. As an apparatus, the embodiments herein broadly describe a laser focus unit that can be used to tune laser equipment used in a manufacturing process. Moreover, the laser focus unit can be used in a production environment to individually calibrate each of a plurality of laser machines using the same reflective datum structure. In this way, machine to machine variation can be tracked and accounted for thereby providing a consistent record of laser machine performance that can be used as a diagnostic tool to identify those laser machines having a record of falling out of compliance and possible reasons why.

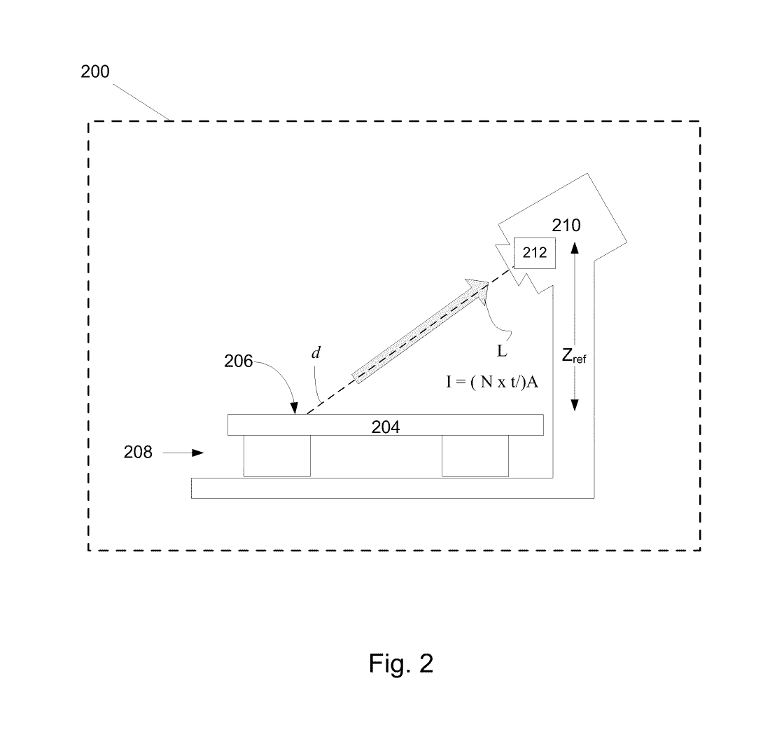

These and other embodiments are discussed below with reference to FIGS. 2-5. However, those skilled in the art will readily appreciate that the detailed description given herein with respect to these figures is for explanatory purposes only and should not be construed as limiting.

FIG. 2 shows representative laser focus unit 200 in accordance with the described embodiments. Laser focus unit 200 can be portable so as to be easily moved from one laser machine to another laser machine in a production environment. Laser focus unit 200 can provide a cost effective and time efficient mechanism for verifying a particular laser machine's compliance to a standard as well as easily and quickly calibrating each of a plurality of laser machines. Laser focus unit 200 can include at least workpiece 204 having reflective datum surface 206 mounted to base structure 208 that also provides support to photon detector unit 210 or more simply detector unit 210. Workpiece 204 can be formed of any durable material such as stainless steel that promotes a highly reflective surface required of reference datum surface 206. Base structure 208 also provides reference position Z_{ref} for detector unit 210 in relation to the reflective datum surface 206. In this way, detector unit 210 remains essentially in the same position relative to reflective datum surface 206 providing consistency during calibration sessions from one machine to another and from one calibration session to another on the same machine.

Light L reflected from reflective datum surface 206 can be received at detector unit 210 with intensity I. Intensity I can be expressed in terms of number N of photons per unit area A and unit time t as:

I=(N×t)/A (1)

Moreover, number N of photons varies as an inverse square of distance d as:

N=Nₒ/d² (2)

where Nₒ is number of photons at d=0 (surface 206)

Since by Eq. (1) and (2), it is clear that intensity I is inversely related to the square of distance d, it is important that distance d remain essentially constant from one set up to another. Light L received at detector 210 can be analyzed for frequency, intensity, polarization and so on. However, in the particular implementation described, laser focus unit 200 relies upon intensity I of the light L received at detector unit 210 and captured by photon capture device 212 in the form of, for example, a CCD imaging device, photo diode and so on. Once a pre-determined amount of time has passed, number N of photons captured by photon capture device 212 are determined and since distance d is fixed, converted to intensity I that correlates well to the intensity of light L at surface 206. Processing resources included in or in association with detector 210 can, in turn, utilize local or remote processing resources to convert intensity I to a numerical value suitable for storage in a data storage medium such as a hard disk drive (HDD), semiconductor memory (such as FLASH) and so on. For example, intensity I can be converted to a digital readout of intensity value that can be processed manually or through computer applications along the lines of a spreadsheet, macro or fully automatic internal processing. In this way, an accurate, robust and low cost solution to determining a position of a focus point for a laser system without the disadvantages described above is provided. Moreover, any change in intensity I can be immediately indentified, characterized, and stored for subsequent processing.

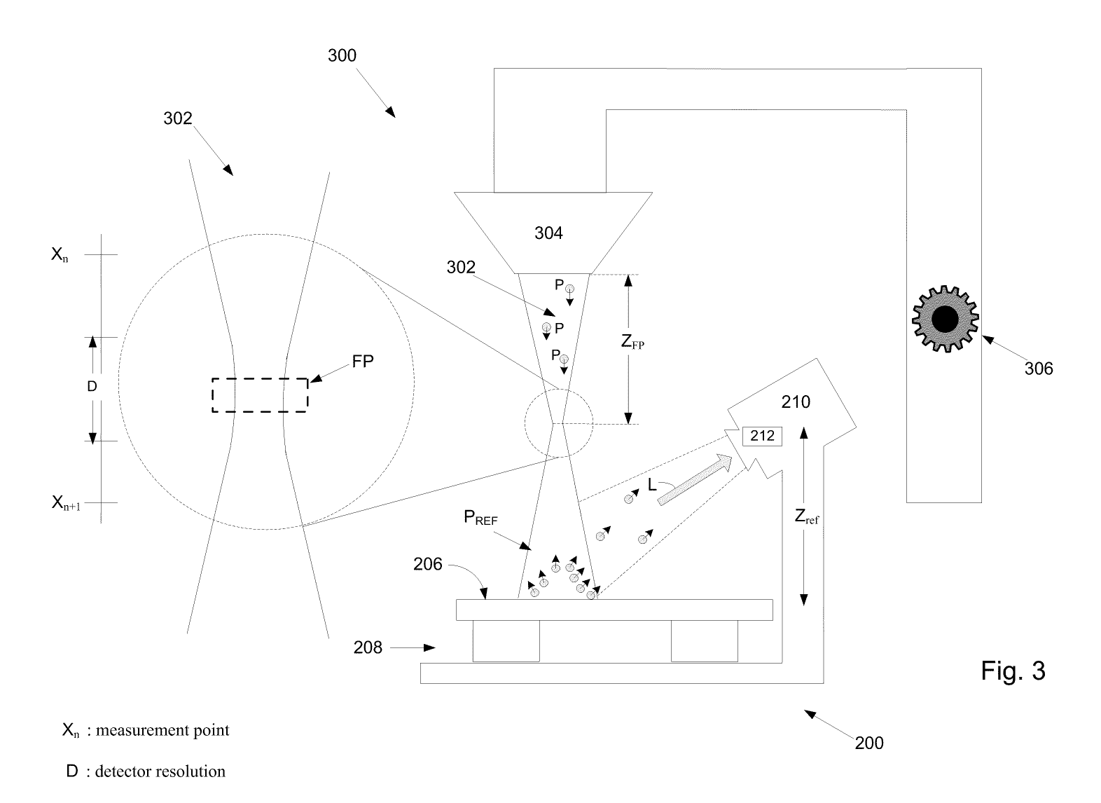

Being portable, laser focus unit 200 can be mounted within laser system 300 as shown in FIG. 3 to determine position Z_{FP} of focus point FP of laser beam 302 in relation to laser beam emitter structure 304 (or alternatively, to reference datum surface 206 as proxy for a production workpiece). Servo controller 306 can be used to move laser beam emitter structure 304 in increments δz in +/−Z that can be on the order to 0.2 mm. In order to determine position Z_{FP} of focus point FP in relation to laser emitter structure 304, laser beam 302 is emitted from laser emitter structure 304. In some cases, laser beam 302 can be emitted as a pulsed beam or continuous beam so long as a sufficient number of data points are made available for subsequent processing. As photons P from laser beam 302 impinge on reflective datum surface 206, some are absorbed whereas other photons P_{REF} are reflected from reference datum surface 206 in a generally uniform manner. It should be noted, however, that the isotropic nature (or lack thereof) of the distribution of reflected photons P_{REF} is immaterial to the determination of Z_{FP} using the techniques described due at least in part to the fixed positioning of the various components of laser focus unit 200. Those of the reflected photons P_{REF} that are captured by photon detector 212 in detector unit 210 are detected as light L from which light intensity I is determined in accordance with eq. (1) and eq. (2). Using servo controller 306 to move laser emitter structure 304, light intensity I can then be converted to intensity value I(z) as a function of the z co-ordinate of laser emitter structure 304 (where z=0 in one embodiment is an initial position). Using servo controller 306 to move laser emitter structure 304 in defined increments of distance Δz (where δz≦Δz) corresponding to measurement points zₙ, intensity I can be evaluated as a function of measurement point zₙ as:

I=I(zₙ) (3)

In this way by collecting a range of data above and below the focus point, a profile map of the intensity I related to z position can be developed where the location of peak intensity will correlate to the laser's focus point or peak energy point. In one embodiment, intensity data can when generated be fed back in real-time to servo controller 306 as the Z position is adjusted making it possible to achieve very high accuracy locating the laser's peak energy point relative to reference datum surface 206 or laser emitter structure 304 using even the most inexpensive manual ball screw Z height adjustment mechanism. By using less expensive Z height adjustment mechanisms can result in substantial savings in capital investment with minimal impact to production because the established laser focus point should not require modification during production.

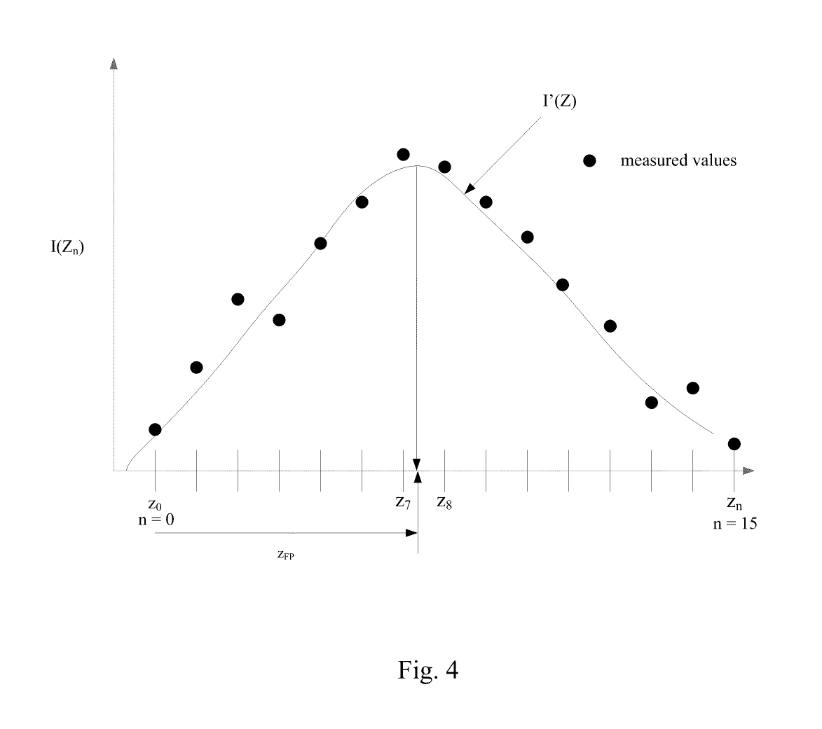

As shown in FIG. 4, once the relationship between intensity I and distance zₙ is known, the position Z_{FP} of focus point FP can be determined as that value of n corresponding to a maximum value of intensity I. Alternatively, focus point FP corresponds to that value of n where the first derivative of I(zₙ) goes to zero, where Z_{FP}=n×zₙ. In this way, a maximum value of the I(zₙ) corresponding to the maximum visible intensity I(Z_{PF}) can be used to provide distance Z_{PF} between laser emitter unit 304 and laser beam focus point FP.

It should be noted, however, that since discrete values (zₙ) are used, intensity I(zₙ) is only an approximation of the actual relationship between intensity I and position z. Therefore, in order to determine a more accurate position of FP, an interpolation operation can be carried out on the data points that make up I(zₙ) in such a way as to provide an approximation of a continuous function I′(s), referred to as a convergence function. There are available many suitable interpolation schemes. For example, a least sum of differences binomial interpolation scheme could be used to accurately determine the exact theoretical peak energy point. Once convergence function I′(s) is known, the maximum intensity level I′ₘₐₓ(Z_{FP}) can be determined providing a good estimation of the position of laser focus point FP. In one embodiment, a least differences second order approximation interpolation technique is used to determine the focus point (peak energy point) of the laser system. This approximation improves accuracy of peak energy point determination by averaging the measurement system error over many data points.

It should be noted that in some cases, it may be desirable to examine each intensity level data point as it is generated in relation to previously generated intensity level data points. For example, by comparing each intensity level data point to a preceding intensity level data points, an indication that a current intensity level data point has a value that is less than at least some of the preceding intensity level data points can indicate a maximum value of intensity level is nearby. At this point a binary like search can be carried out to zero in on the actual location corresponding to the actual maximum intensity level which of course would indicate the location of focus point FP.

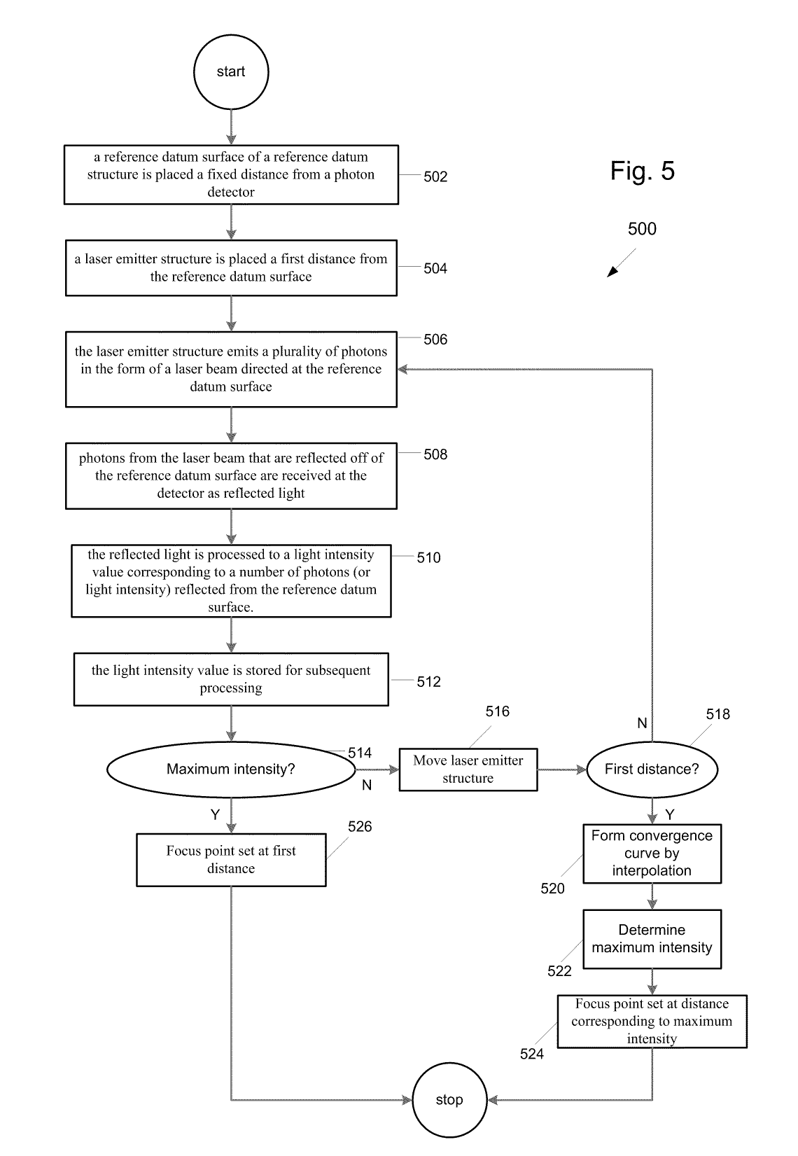

FIG. 5 shows a flowchart detailing process 500 for determining a focus point of a laser system in accordance with the described embodiments. Accordingly, a reference datum surface of a reference datum structure is placed a fixed distance from a photon detector at 502. At 504, a laser emitter structure is placed a first distance from the reference datum surface. At 506, the laser emitter structure emits a plurality of photons in the form of a laser beam directed at the reference datum surface. At 508, photons from the laser beam that are reflected off of the reference datum surface are received at the detector as reflected light. At 510, the reflected light is processed to a light intensity value corresponding to a number of photons (or light intensity) reflected from the reference datum surface. At 512, the light intensity value is stored for subsequent processing. At 514, a determination is made if the stored intensity value corresponds to a maximum intensity value. If it is determined at 514 that the stored intensity value is not the maximum intensity value, and then at 516 the laser emitter structure is moved a pre-determined amount from the first distance to a second distance from the reference datum structure. Process steps 506 through 516 are repeated until it has been determined at 518 that the laser emitter structure has moved a substantial portion of the first distance towards the reference datum surface at which point, an interpolation operation is performed on the stored intensity values at 520 to form a convergence curve. At 522, maximum intensity value of the convergence curve is determined and at 524, a distance corresponding to a maximum value of the convergence curve is set as the focus point of the laser system.

Returning to the determining at 514, if it is determined that the light intensity is the maximum light intensity, and then the focus point of the laser system is set at the first distance at 526.

The various aspects, embodiments, implementations or features of the embodiments can be used separately or in any combination. The embodiments can be implemented by software, hardware or a combination of hardware and software. The embodiments can also be implemented as computer readable code on a computer readable medium for controlling a laser welding apparatus. The invention can be embodied as computer readable code on a computer readable medium for controlling a manufacturing line used to fabricate housings. The computer readable medium is any data storage device that can store data which can thereafter be read by a computer system. Examples of the computer readable medium include read-only memory, random-access memory, CD-ROMs, DVDs, magnetic tape, optical data storage, and devices. The computer readable medium can also be distributed over network-coupled computer systems so that the computer readable code is stored and executed in a distributed fashion.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method of automatically determining a focus point of a laser system, comprising:
placing a reference datum surface a first distance from a laser emitter structure of the laser system, the laser emitter structure arranged to emit a plurality of photons as a laser beam;
directing the laser beam from the laser emitter structure to the reference datum surface;
determining a light intensity level based upon a number of photons reflected from the reference datum structure captured at a photon detector, the photon detector being a fixed distance from the reference datum surface;
moving the laser emitter structure a pre-determined distance;
repeating the directing, the determining, and the moving until the light intensity is determined to be a maximum light intensity; and
identifying the focus point of the laser system based upon a location of the laser emitter structure in relation to the reference datum surface corresponding to the maximum light intensity.

2. The method as recited in claim 1, further comprising:
associating a laser focus unit with the laser system, the laser focus unit comprising:
a support structure having at least one surface as the reference datum surface, and
a fixed length arm used to attach the support structure to the photon detector in such a way that a distance between the reference datum surface and the photon detector is fixed.

3. The method as recited in claim 2, wherein associating comprises:
placing the support structure in proximity to the laser emitter structure such that at least a portion of the reference datum structure is aligned with the laser emitter structure.

4. The method as recited in claim 1, wherein at least a portion of the reference datum surface is formed of stainless steel.

5. The method as recited in claim 1, wherein the laser emitter structure is coupled to a servo system, the servo system arranged to move the laser emitter structure the pre-determined distance.

6. The method as recited in claim 5, wherein the servo system automatically moves the laser emitter structure the pre-determined distance based upon information provided by the photon detector.

7. An apparatus for determining a focus point of a laser beam formed of a plurality of photons emitted by a laser emitter of a laser system comprising:
a support structure having at least one surface as the reference datum surface;
a photon detector;
a fixed length arm used to attach the photon detector and the support structure in such a way that a distance between the reference datum surface and the photon detector is fixed, wherein the apparatus automatically determines the focus point of the laser beam by:
directing the laser beam at the reference datum surface by the laser emitter such that at least some of the plurality of photons comprising the laser beam are reflected off of the reference datum surface,
capturing at least some of the reflected photons by the photon detector,
determining and storing for subsequent processing intensity level data in accordance with the reflected photons captured by the photon detector, and
moving the laser emitter in relation to the reference datum surface a predetermined distance, wherein the directing, capturing, and determining and storing are repeated until the intensity level is determined to be at least a relative maximum intensity level.

8. The apparatus as recited in claim 7, further comprising:
retrieving the stored intensity level data;
interpolating the retrieved intensity level data;
identifying a maximum intensity level based upon the interpolated intensity level data; and
using a distance from the laser emitter corresponding to the identified maximum intensity level as the focus point of the laser system.

9. The apparatus as recited in claim 8, wherein the interpolation is a second order polynomial interpolation.

10. The apparatus as recited in claim 7, wherein the reference datum surface is formed of stainless steel.

11. A non-transitory computer readable medium for storing a computer program executable by a processor for determining a focus point of a laser system, comprising:
computer code for placing a reference datum surface a first distance from a laser emitter structure of the laser system, the laser emitter structure arranged to emit a plurality of photons as a laser beam;
computer code for directing the laser beam from the laser emitter structure to the reference datum surface;
computer code for determining a light intensity level based upon a number of photons reflected from the reference datum structure captured at a photon detector, the photon detector being a fixed distance from the reference datum surface; computer code for moving the laser emitter structures a pre-determined distance;
computer code for repeating the directing, the determining, and the moving until the light intensity is determined to be a maximum light intensity; and
computer code for identifying the focus point of the laser system based upon a location of the laser emitter structure in relation to the reference datum surface corresponding to the maximum light intensity.

12. The computer readable medium as recited in claim 11, further comprising:
computer code for associating a laser focus unit with the laser system, the laser focus unit comprising:
a support structure having at least one surface as the reference datum surface, and
a fixed length arm used to attach the support structure to the photon detector in such a way that a distance between the reference datum surface and the photon detector is fixed.

13. Computer readable medium as recited in claim 12, wherein computer code for associating comprises:
computer code for placing the support structure in proximity to the laser emitter structure such that at least a portion of the reference datum structure is aligned with the laser emitter structure.

14. Computer readable medium as recited in claim 11, wherein at least a portion of the reference datum surface is formed of stainless steel.

15. Computer readable medium as recited in claim 11, wherein the laser emitter structure is coupled to a servo system, the servo system arranged to move the laser emitter structure the pre-determined distance.

16. Computer readable medium as recited in claim 15, wherein the servo system automatically moves the laser emitter structure the pre-determined distance based upon information provided by the photon detector.

17. A method for calibrating a plurality of laser machines, comprising:
calibrating a first one of the plurality of laser machines using the laser focus apparatus as recited in claim 7;
moving the automatic laser focus apparatus to another one of the plurality of laser machines;
calibrating the another one of the plurality of laser machines using the automatic laser focus apparatus; and
repeating the moving and calibrating until substantially all of the plurality of laser machines are calibrated, wherein calibration data for each of the calibrated laser machines are stored in an external computing system.

18. The method as recited in claim 17, further comprising:
periodically testing selected ones of the plurality of laser machines using the automatic laser focus apparatus by:
retrieving the stored calibration data from the external computing system corresponding to the selected laser system;
determining the focus point of the selected laser system;
comparing the determined focus point with the retrieved calibration data; and
adjusting the selected laser system when the comparing indicates that the selected laser system is out of compliance.
